(19) United States
(12) Patent Application Publication
(10) Pub. No.: US 2013/0146413 A1
(43) Pub. Date: Jun. 13, 2013

(54) OVERLOAD PROTECTION DRIVING MECHANISM

(71) Applicant: Shanghai Kohler Electronics, Ltd., Shanghai (CN)

(72) Inventors: Yihua Wang, Shanghai (CN); Xiaojun Zhou, Shanghai (CN)

(73) Assignee: Shanghai Kohler Electronics, Ltd., Shanghai (CN)

(21) Appl. No.: 13/708,564

(22) Filed: Dec. 7, 2012

(30) Foreign Application Priority Data
Dec. 9, 2011 (CN) 201110410419.0

(51) Int. Cl. F16D 43/21

(52) U.S. Cl. CPC F16D 43/21
USPC 192/56.1

(57) ABSTRACT

An overload protection driving mechanism is provided. The driving mechanism includes a first driving assembly having a mounting part, a second driving assembly having a friction part, and a locking assembly for slipably locking the first driving assembly and the second driving assembly. The locking assembly includes a friction surface matching an inner ring surface of the friction part and a mounting hole matching the mounting part.

### CROSS-REFERENCE TO RELATED APPLICATIONS

This application claims the benefit of and priority to Chinese Application No. 201110410419.0, titled “Overload Protection Driving Mechanism” and filed Dec. 9, 2011, which is incorporated herein by reference in its entirety.

### FIELD

The invention relates to the field of driving mechanisms having gears, overload protection for such driving mechanisms, and, in particular, to an overload protection driving mechanism.

### BACKGROUND

Driving mechanisms are widely applied in engineering. A common driving structure is connected with one power unit and one load device, and transmits power to a load by a driving mechanism, but sometimes the driving mechanism can not drive the load due to excessive load. If a certain overload protective device is not arranged, the driving mechanism will be damaged or a power mechanism will be further damaged. Overload protection mechanisms generally allow the driving mechanism to run idle or skid (e.g., slip) in case of excessive load, thus damage to the driving mechanism or the power mechanism can be effectively prevented.

Chinese Patent Publication No. CN201934611 discloses a gear overload protection device. FIGS. 1A and 1B are representative of prior art that may include Chinese Patent Publication No. CN201934611. As shown in FIGS. 1A and 1B, the gear overload protection device includes an output shaft 1′ and a driving gear 2′ mounted on the output shaft 1′. The lower end of the output shaft 1′ has a mounting part 11′ extending downward, the outline of the mounting part 11′ is columnar shape obtained after two planes are relatively cut off from cylindrical shape, and the lower end of the mounting part 11′ has a cylindrical mounting shaft part 12′ extending downward. The driving gear 2′ is mounted on the mounting part 11′ of the output shaft 1′ by a clutch structure. The clutch structure ensures that the driving gear 2′ slips with respect to the output shaft 1′ in case of excessive load of the output shaft 1′. The clutch structure includes one driving friction plate 3′ and two driven friction plates 4′, wherein the driving friction plate 3′, as an embedded piece, is injection molded with the driving gear 2′ together so that the driving friction plate 3′ can rotate along with the driving gear 2′, the central part of the driving friction plate 3′ also has a punched hole 31′ for the mounting part 11′ of the output shaft 1′ to pass through, and the mounting part 11′ passes through the punched hole 31′ of the driving friction plate and can rotate relatively. The two driven friction plates 4′ are connected on the mounting part 11′ of the output shaft 1′ and can rotate along with the output shaft 1′. That is, the central part of the two driven friction plates 4′ is provided with a locating hole 41′ with an outline matching the mounting part, the driven friction plates 4′ are sleeved on the mounting part 11′ by the locating hole 41′ and therefore can rotate along with the output shaft 1′; and the two driven friction plates 4′ are respectively positioned at the upside and downside of the driving friction plate 3′, and the mounting part 11′ of the output shaft 1′ is externally provided with a pressing device which presses the two driven friction plates 4′ and the driving friction plate 3′ together, thus the two driven friction plates 4′ are respectively in close contact with the front end face and rear end face of the driving friction plate 3′. The pressing device is a pressing point 5′ in pressing contact with the driven friction plate 4′ at the outermost end, which is formed after riveting at the lower end of the output shaft 1′, and friction force is controlled by the pressing point at one end of the output shaft.

The operating principle of the gear overload protection device is as follows: when the output shaft 1′ rotates, the output shaft does not directly drive the driving gear 2′, but transmits torque by friction force produced by the contact surface between the driven friction plates 4′ and the driving friction plate 3′, and then the driving friction plate 3′ drives the driving gear 2′ to rotate. For the driven friction plates 4′, when the torque on the output shaft 1′ exceeds the friction force between the driving friction plate 3′ and the two driven friction plates 4′, the driving friction plate 3′ and the driven friction plates 4′ are in a separating or slipping state, thus gears will not be damaged.

Although the above technical solution can effectively protect gears, there are still some disadvantages: 1. A considerable part of output torque of the output shaft will be wasted in the mutual friction between the driving friction plate and the driven friction plates, thus energy consumption is high. 2. A gap shall be reserved at the end faces of the friction plates so that the friction plates can freely rotate without obstruction, but this will have certain influence on concentricity. 3. After the friction plates are arranged as required, generally critical friction force can not be adjusted. If load is changing, the friction plates shall be replaced as required.

### SUMMARY

Objects of the present disclosure include providing an overload protection driving structure which has high efficiency, can help ensure concentricity, and can adjust friction force.

One embodiment of the disclosure provides an overload protection driving mechanism including a first driving assembly and a second driving assembly. The first driving assembly is provided with a mounting part, the second driving assembly is provided with a friction part. The driving mechanism further includes a locking assembly for locking the first driving assembly and the second driving assembly. The locking assembly includes a friction surface matching the friction part and a mounting hole matching the mounting part. The locking assembly is disc-shaped. The friction surface is positioned at the end face of the locking assembly. The friction surface matches the inner ring surface of the friction part.

According to some embodiments, the first driving assembly is further provided with a fixing part. The second driving assembly is further provided with a receiving part for receiving the fixing part. The fixing part is connected with the locking assembly.

According to some embodiments, the fixing part is disc-shaped and is sleeved on the first driving assembly. The fixing part is provided with a plurality of first bolt holes. The locking assembly is provided with a plurality of second bolt holes corresponding to the first bolt holes. The first bolt holes are connected with the second bolt holes by bolts.

According to some embodiments, the end face of the fixing part fits the inner ring surface of the receiving part. According to some embodiments, the end face of the fixing part and the inner ring surface of the receiving part are in clearance fit. According to some embodiments, an annular step is arranged between the receiving part and the friction part, and inside diameter of the annular step is smaller than outside diameter of the fixing part. According to some embodiments, the first driving assembly is a shaft. According to some embodiments, the fixing part and the shaft are integrally formed. According to some embodiments, the second driving assembly is a gear. According to some embodiments, the end face of the shaft is splined, and a portion of the shaft passes through the fixing part to form the mounting part. According to some embodiments, the mounting part is a spline which can be embedded into the mounting hole. According to some embodiments, the inner ring surface of the friction part and the friction surface are slopes. According to some embodiments, the width of the end face of the fixing part is the same as that of the inner ring surface of the receiving part. According to some embodiments, the inner ring surface of the friction part and the friction surface have the same width. According to some embodiments, the mounting part and the mounting hole have the same length. According to one embodiment, the overload protection driving mechanism includes a first driving assembly comprising a fixing part, a second driving assembly having a frustoconical friction part and a receiving part configured to receive the fixing part, and a locking assembly comprising a frustoconical friction surface configured to engage the friction part, wherein the locking assembly couples to the fixing part such that the second driving assembly is slipably locked therebetween. Advantageously, embodiments of the present invention are able to provide friction force by the friction surface of the locking assembly, and the inner ring surface of the friction part, so as to drive the second driving assembly, the torque of the first driving assembly is essentially used for output, and thereby the driving efficiency is relatively high.

### BRIEF DESCRIPTION OF THE DRAWINGS

FIG. 1A is an exploded view of an existing gear overload protection device; and

FIG. 1B is a partial sectional view of the existing gear overload protection device.

FIG. 2 is a perspective view of an overload protection driving mechanism, according to an exemplary embodiment of the invention;

FIG. 3 is a cross-sectional view of the embodiment of FIG. 2 the overload protection driving mechanism; and

FIG. 4 is an exploded view of the embodiment FIG. 2 of the overload protection driving mechanism.

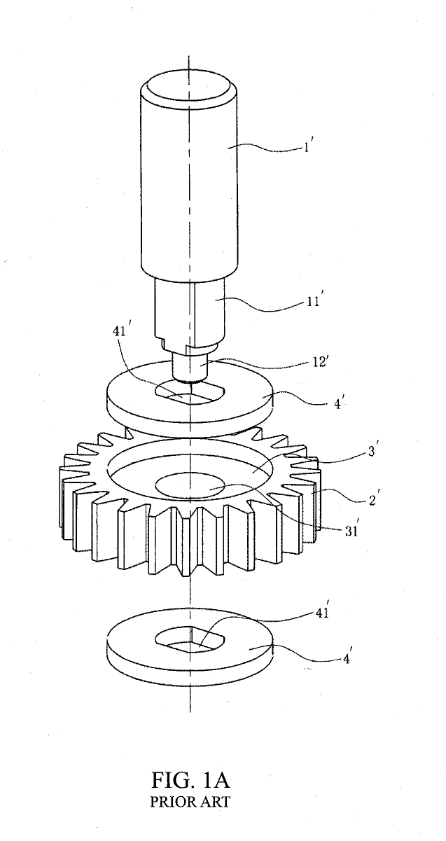

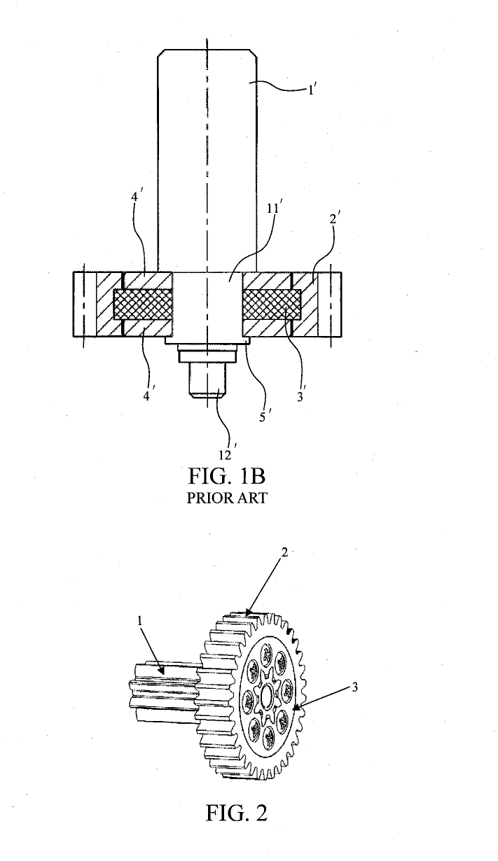

### DETAILED DESCRIPTION

As shown in FIGS. 2 to 4, an overload protection driving mechanism includes a first driving assembly 1 and a second driving assembly 2. The first driving assembly 1 is provided with a mounting part 10. The second driving assembly 2 is provided with a friction part 20. The driving mechanism further includes a locking assembly 3 for locking the first driving assembly 1 and the second driving assembly 2. The locking assembly 3 includes a friction surface 30 matching the friction part 20 and a mounting hole 31 matching the mounting part 10. The locking assembly 3 may be disc-shaped. The friction surface 30 is positioned at the end face of the locking assembly 3. The friction surface 30 matches the inner ring surface of the friction part 20.

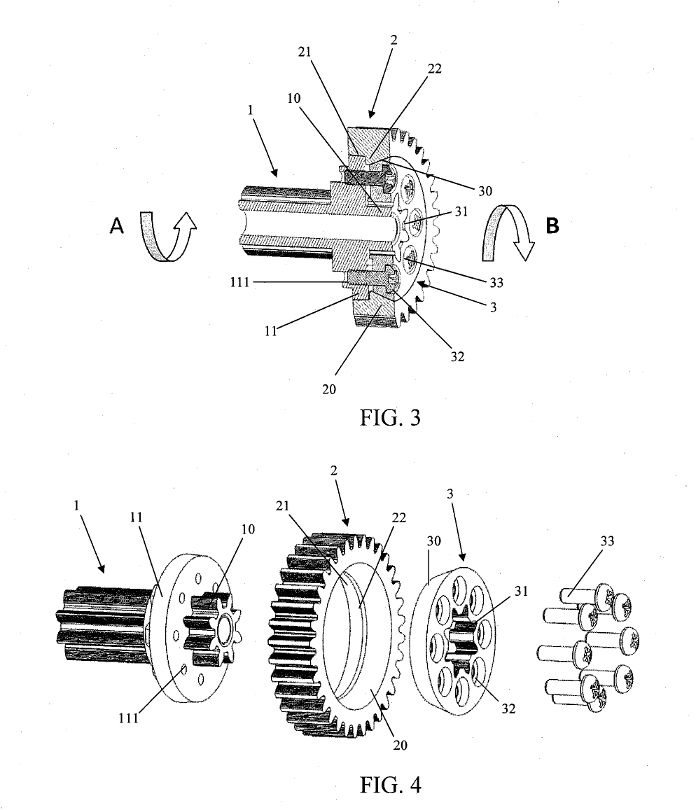

During mounting, the mounting part 10 of the first driving assembly 1 is inserted into the mounting hole 31 of the locking assembly 3, thus completing the mounting of the first driving assembly 1 and the locking assembly 3. The friction surface 30 at the end face of the locking assembly 3 then matches the friction part 20 of the second driving assembly 2 to produce friction force. In this way, the locking assembly 3 connects the first driving assembly 1 and the second driving assembly 2. When the first driving assembly 1 is connected with a power source (e.g., a motor, an electric motor, motor drive components, etc.), the first driving assembly 1 drives the locking assembly 3 causing the first drive assembly and the locking assembly to rotate together by the mounting part 10. Since friction force is produced between the friction surface 30 of the locking assembly 3 and the friction part 20 of the second driving assembly 2, the friction force can further drive (e.g., cause) the second driving assembly 2 to rotate when external load is within normal range. In case of excessive external load, the friction force between the friction surface 30 and the friction part 20 exceeds a critical value, and the locking assembly 3 skids (e.g., slips) and rotates with respect to the second driving assembly 2. The skidding or slipping is intended to prevent damage to the second driving assembly 2. Since the matching surface between the friction surface 30 and the friction part 20 is positioned at the end face of the locking assembly, the direction of the friction force acting on the second driving assembly is substantially the same as (e.g., consistent with) the rotation direction (as shown in FIG. 3) of the first driving assembly and the second driving assembly, thus the torque produced by the first driving assembly is basically used for output, and driving efficiency is relatively high.

In the embodiment shown, the mounting hole 31 is positioned at the center of the locking assembly 3 and the mounting part 10 is also positioned at the central axis of the first driving assembly 1. The mounting hole also can be positioned at other positions of the locking assembly, provided that the mounting hole and the mounting part can match to have the function of driving the locking assembly.

According to one embodiment, the first driving assembly 1 is further provided with a fixing part 11, and the second driving assembly 2 is further provided with a receiving part 21 for receiving the fixing part 11. The fixing part 11 is connected with the locking assembly 3, thus ensuring that the locking assembly 3 will not loosen when driving by the second driving assembly 2.

In the embodiment shown, the fixing part 11 is disc-shaped and is sleeved on the first driving assembly 1, the fixing part 11 is provided with a plurality of first bolt holes 111, the locking assembly 3 is provided with a plurality of second bolt holes 32 corresponding to the first bolt holes 111, and the first bolt holes 111 are connected with the second bolt holes 32 by bolts 33 (e.g., screws, etc.). The fixing part 11 abuts on (e.g., is adjacent to) the mounting part 10, and the first bolt holes 111 are aligned with the second bolt holes 32 after the mounting part 10 is inserted into the mounting hole 31. As a result of the bolt connection, the distance between the locking assembly 3 and the fixing part 11 can be adjusted by the bolts 33. When the distance between the locking assembly 3 and the fixing part 11 is longer, the contact area between the friction surface 30 of the locking assembly 3 and the friction part 20 of the second driving assembly 2 is smaller, and the pressure between the friction surface 30 and the friction part 20 is also smaller, thus the friction force produced is also smaller; but when the distance between the locking assembly 3 and the fixing part 11 is shorter, the contact area between the friction surface 30 of the locking assembly 3 and the friction part 20 of the second driving assembly 2 is larger, and the pressure between the friction surface 30 and the friction part 20 is also larger, thus the friction force produced is also larger. In this way, the distance between the fixing part 11 and the locking assembly 3 can be adjusted by the bolts 33, thus adjusting critical value of the friction force. Accordingly, adjustment can be conveniently performed according to changes in load such that overload protection has better applicability. The mounting part 10 and the mounting hole 31 may have a clearance fit therebetween, thus when the fixing part 11 and the locking assembly 3 are adjusted, smaller (i.e., less) friction force or no friction force will be produced thus making it easy (e.g., convenient) to adjust the distance between the locking assembly 3 and the fixing part 11.

According to one embodiment, the end face of the fixing part 11 fits the inner ring surface of the receiving part 21, and the fitting between the fixing part 11 and the inner ring surface of the receiving part 21 can ensure rotation concentricity of the output shaft.

According to one embodiment, the end face of the fixing part 11 and the inner ring surface of the receiving part 21 are in clearance fit. In this way, when the fixing part 11 rotates in relation to the inner ring surface of the receiving part 21, nearly no friction force will be produced between the end face of the fixing part 11 and the inner ring surface of the receiving part 21, or the friction force is relatively small so that it can be ignored. This is because the embodiment is not directly driven by the first driving assembly 1 and the second driving assembly 2, but indirectly driven by the locking assembly 3.

According to one embodiment, when the end face of the fixing part 11 fits the inner ring surface of the receiving part 21, a certain amount of friction force also can be produced, and this friction force, along with the friction force produced between the locking assembly 3 and the friction part 20. is sufficient to drive the second driving assembly 2.

According to one embodiment, an annular step 22 is arranged between the receiving part 21 and the friction part 20, and inside diameter of the annular step 22 is smaller than outside diameter of the fixing part 11. The annular step 22 is used for locating the disc-shaped fixing part 11 to prevent the fixing part 11 from contacting the friction surface 30.

In the embodiment shown, the first driving assembly 1 is a shaft and the second driving assembly 2 is a gear. The invention is not limited to driving fit between the shaft and the gear, and other kinds of driving fit also can be adopted.

According to one embodiment, the fixing part 11 and the shaft are integrally formed. According to another embodiment, the end face of the shaft is splined, and a portion of the shaft passes through the fixing part 11 to form the mounting part 10. The splined mounting part 10 matches the mounting hole 31 and the shape of the mounting hole 31 is corresponding to that of the mounting part 10. Since the splined mounting part 10 is adopted, the mounting part 10 can drive the locking assembly 3 to rotate together around the central line of the shaft when it is inserted into the mounting hole 31. The mounting part 10 also can be a spline of other shapes, provided that the mounting part can have the purpose of driving the locking assembly 3.

According to one embodiment, the shaft also can be a shaft of any other shape, only the mounting part 10 is a spline which can be embedded into the mounting hole 31.

According to one embodiment, the inner ring surface of the friction part 20 and the friction surface 30 are slopes (e.g., bevels, inclines, etc.). As shown in FIG. 4, the left side and the right side of the second driving assembly 2 are the receiving part 21 and the friction part 20, respectively. The inside diameter of the slopes that are closer to the receiving part 21 are smaller than that of the slopes that are away from the receiving part 21. During mounting, the shaft is inserted from the left side of the second driving assembly 2 to pass through the inner ring of the gear, and the fixing part 11 is positioned at the annular step 22. Then the locking assembly 3 is mounted from the right side into the friction part 20 of the gear, and the mounting part 10 is inserted into the mounting hole 31. Since the inner ring surface of the friction part 20 is a slope, and the friction surface 30 is also a slope, the inside diameter of the slopes that are closer to the receiving part 21 are smaller than that of the slopes that are away from the receiving part 21. Thus, the locking assembly 3 can be conveniently and gradually deeply inserted into the friction part 20. Finally, the locking assembly 3 is fixed by the bolts 33, which adjust the distance between the locking assembly 3 and the fixing part 11. The inner ring surface of the friction part 20 and the friction surface 30 also can be planes, which similarly can have the function of driving the second driving assembly 2 through friction force.

According to one embodiment, the end face of the fixing part 11 and the inner ring surface of the receiving part 21 can be both planes, slopes, inclined planes, etc. According to the embodiment shown, the width of the end face of the fixing part 11 is the same as that of the inner ring surface of the receiving part 21, the width of the inner ring surface of the friction part 20 is the same as that of the friction surface 30, and the length of the mounting part 10 and is the same as that of the mounting hole 31. In this way, the outline (e.g., shape) of the whole driving mechanism may be the most compact and orderly when the contact surface between the friction part 20 and the friction surface 30 is the largest.

What is claimed is:

1. An overload protection driving mechanism, comprising:
a first driving assembly having a mounting part;
a second driving assembly having a friction part; and
a locking assembly for slipably locking the first driving assembly and the second driving assembly, the locking assembly comprising:
a friction surface matching an inner ring surface of the friction part; and
a mounting hole matching the mounting part.

2. The driving mechanism according to claim 1, wherein the first driving assembly comprises a fixing part, the second driving assembly comprises a receiving part for receiving the fixing part, and the fixing part is connected with the locking assembly.

3. The driving mechanism according to claim 2, wherein the fixing part is sleeved on the first driving assembly and defines a plurality of first holes, and wherein the locking assembly defines a plurality of second holes corresponding to the plurality of first holes.

4. The driving mechanism according to claim 3, wherein an end face of the fixing part fits an inner ring surface of the receiving part.

5. The driving mechanism according to claim 4, wherein the end face of the fixing part and the inner ring surface of the receiving part are in clearance fit.

6. The driving mechanism according to claim 4, wherein the width of an end face of the fixing part is substantially the same as that of the inner ring surface of the receiving part.

7. The driving mechanism according to claim 3, wherein an annular step is arranged between the receiving part and the friction part, and an inside diameter of the annular step is smaller than an outside diameter of the fixing part.

8. The driving mechanism according to claim 3, wherein the first driving assembly is a shaft.

9. The driving mechanism according to claim 8, wherein the fixing part and the shaft are integrally formed.

10. The driving mechanism according to claim 8, wherein the second driving assembly is a gear.

11. The driving mechanism according to claim 8, wherein the shaft is splined, and a portion of the shaft passes through the fixing part to form the mounting part.

12. The driving mechanism according to claim 1, wherein the mounting part comprises a spline configured to be embedded into the mounting hole.

13. The driving mechanism according to claim 1, wherein the inner ring surface of the friction part and the friction surface comprise beveled surfaces.

14. The driving mechanism according to claim 1, wherein the inner ring surface of the friction part and the friction surface have the substantially same width.

15. The driving mechanism according to claim 1, wherein the mounting part and the mounting hole have the same length.

16. The driving mechanism according to claim 1, wherein the locking assembly is disc-shaped.

17. The driving mechanism according to claim 3, wherein the first holes are connected with the second holes by bolts.

18. An overload protection driving mechanism, comprising:
a first driving assembly comprising a fixing part;
a second driving assembly having a frustoconical friction part and a receiving part configured to receive the fixing part; and
a locking assembly comprising a frustoconical friction surface configured to engage the friction part;
wherein the locking assembly couples to the fixing part such that the second driving assembly is slipably locked therebetween.

19. The driving mechanism according to claim 18, wherein the first driving assembly comprises a mounting part, and the locking assembly comprises a mounting hole configured to receive the mounting part.

20. The driving mechanism according to claim 18, wherein the locking assembly is fastened to the first driving assembly, and wherein adjusting the fasteners adjusts the critical friction force at which the locking assembly slips relative to the second driving assembly.
